(19) United States
(12) Patent Application Publication
(10) Pub. No.: US 2005/0229659 A1
(43) Pub. Date: Oct. 20, 2005

(54) Two-way assembling device for an auxiliary lock

(76) Inventor: Ching-Sung Lee, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/826,265

(22) Filed: Apr. 19, 2004

(51) Int. Cl. E05B 65/00; E05B 55/00; E04B 2/00

(52) U.S. Cl. 70/144; 70/91

(57) ABSTRACT

A two-way assembling device for the auxiliary lock includes a monolithic assembling plate consisting of a first side and a second side. The first side forms a first engaging upright portion with a first diameter while the second side forming a second engaging upright portion with a second diameter. A door plank has an assembling hole with a first diameter or a second diameter which is able to engage with either of the first engaging upright portion or the second engaging upright portion. Subsequently, the monolithic assembling plate is secured to the assembling hole of the door plank. Finally, a rose escutcheon and a doorknob are secured to the door plank through the monolithic assembling plate.

### BACKGROUND OF THE INVENTION

1. Field of the Invention

The present invention relates to a two-way assembling device for an auxiliary lock. More particularly, the present invention relates to a two-way assembling device having a pair of engaging portions suitable for two different sizes of assembling holes of door planks.

2. Description of the Related Art

Taiwanese Pat. No.271184, entitled “AUXILIARY LOCK STRUCTURE HAVING A SINGLE ASSEMBLING DEVICE,” discloses a conventional assembling device for an auxiliary lock. The auxiliary lock includes an assembling plate, a rose escutcheon, at least two first screw members and at least two second screw members. The conventional assembling plate consists of an engaging upright portion, an axial hole and a pair of first screw holes. The engaging upright portion surrounds an axis of the assembling plate and is adapted to engage with a periphery of an assembling hole of the door plank. The axial hole and the first screw holes are corresponding to an engaging slot and a pair of through holes of a conventional door lock mechanism. Furthermore, the assembling plate includes a pair of second screw holes.

The rose escutcheon connects to a doorknob such that user can operate it for freely rotation. The doorknob further connects to an actuating rod which extends through the axial hole of the assembling plate and into the engaging slot of the conventional door lock mechanism. The rose escutcheon is provided with a pair of first through holes located at either side of the doorknob, and each of the first through holes is corresponding to the first screw hole of the assembling plate. In assembling operation, the second screw members extend through the second screw holes of the assembling plate so as to mount the assembling plate on the door plank. Subsequently, the actuating rod extends through the axial hole of the assembling plate and into the engaging slot of the conventional door lock mechanism. Finally, the first screw members successively extend through the first through holes of the rose escutcheon and the first screw holes of the assembling plate so as to mount the auxiliary lock structure on the door plank in proper.

However, the above-mentioned assembling plate and rose escutcheon are able to firmly mount the door lock mechanism to the assembling hole of the door plank. Generally, diameters of the assembling hole of the door plank are 38 mm and 54 mm for example. However, the engaging upright portion of the assembling plate engaged with the periphery of the assembling hole of the door plank is sized one of the two diameters. Namely, a single size of the engaging upright portion of the assembling plate is unsuitable for the two diameters of the assembling hole of the door plank at the same time. There is a need for two molding assemblies for manufacturing the two sizes of the engaging upright portion of the assembling plate. Consequently, it may increase manufacturing cost of the molding assemblies.

The present invention intends to provide a two-way assembling device for an auxiliary lock having a monolithic assembling plate. The monolithic assembling plate includes a pair of engaging upright portions at its opposite side for engaging with two different sizes of assembling holes of door planks in such a way to mitigate and overcome the above problem.

### SUMMARY OF THE INVENTION

The primary objective of this invention is to provide a two-way assembling device for an auxiliary lock, which has a monolithic assembling plate forming a pair of engaging upright portions at its either sides. Each of the engaging upright portions of the monolithic assembling plate is suitable for each of two different sizes of assembling holes of door planks. Thereby, it may reduce members of the auxiliary lock and simplify the structure of the assembling plate.

The two-way assembling device for the auxiliary lock in accordance with the present invention includes a monolithic assembling plate consisting of a first side and a second side. The first side forms a first engaging upright portion with a first diameter while the second side forming a second engaging upright portion with a second diameter. A door plank has an assembling hole with a first diameter or a second diameter which is able to engage with either of the first engaging upright portion or the second engaging upright portion. Subsequently, the monolithic assembling plate is secured to the assembling hole of the door plank. Finally, a rose escutcheon and a doorknob are secured to the door plank through the monolithic assembling plate.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings wherein:

FIG. 1 is an exploded perspective view of a two-way assembling device for an auxiliary lock in accordance with a preferred embodiment of the present invention;

FIG. 2 is an assembled cross-sectional view of the two-way assembling device for the auxiliary lock in accordance with the preferred embodiment of the present invention;

FIG. 3 is another exploded perspective view of the two-way assembling device for the auxiliary lock in an alternative assembling relationship in accordance with the preferred embodiment of the present invention; and

FIG. 4 is another assembled cross-sectional view of the two-way assembling device for the auxiliary lock in an alternative assembling relationship in accordance with the preferred embodiment of the present invention.

### DETAILED DESCRIPTION OF THE INVENTION

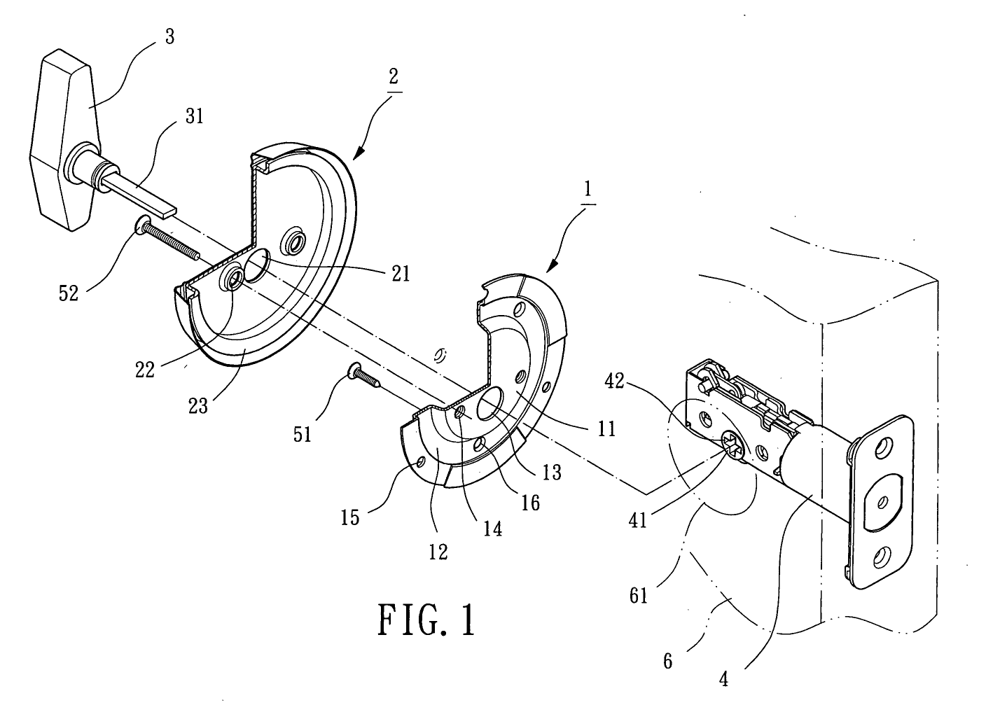

Referring to FIGS. 1 through 4, an auxiliary lock in accordance with the preferred embodiment of the present invention includes a monolithic assembling plate 1, a rose escutcheon 2, a doorknob 3 and a latch mechanism 4.

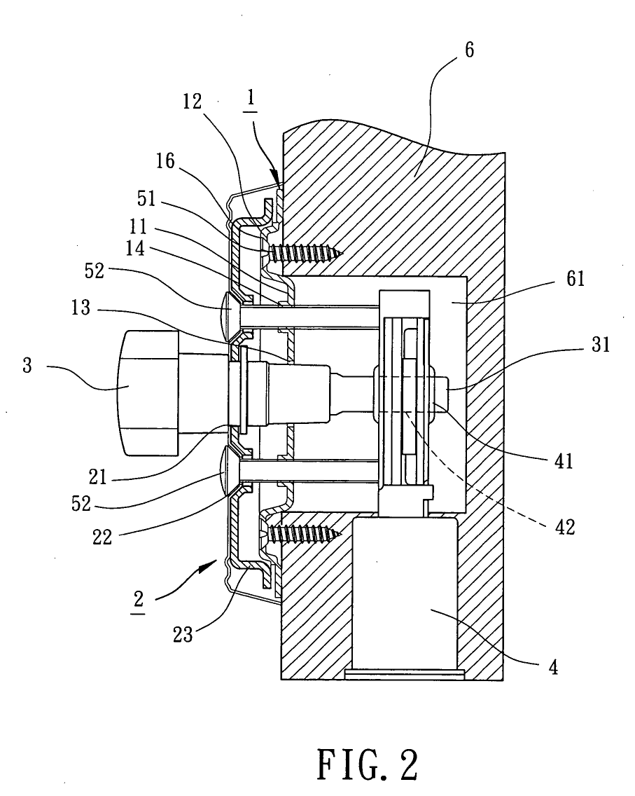

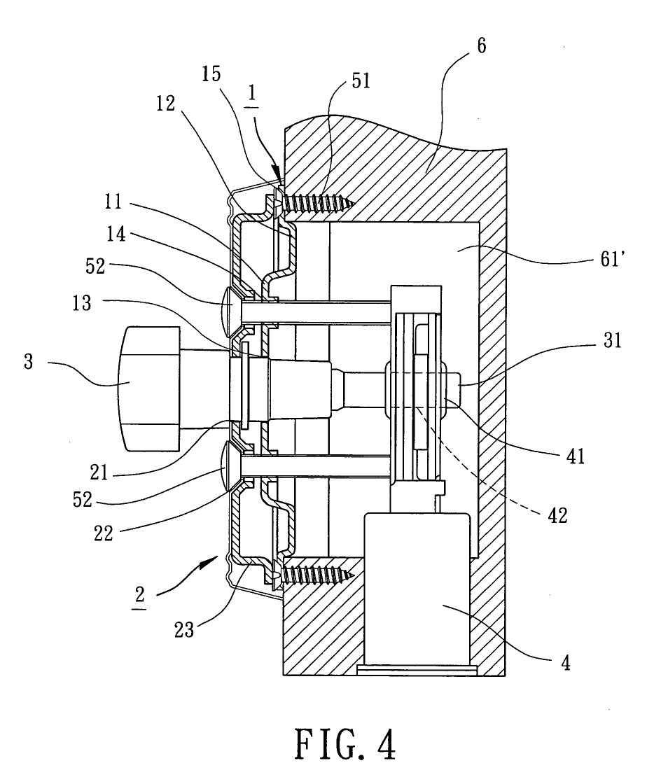

Referring again to FIGS. 1 and 2, construction of the monolithic assembling plate 1 shall be described in detail. The monolithic assembling plate 1 is a circular plate made of a metal sheet by means of punching. The material of the monolithic assembling plate 1 is relatively rigid and strong to withstand normal usage of the auxiliary lock. The monolithic assembling plate 1 consists of a first side and a second side. The first side forms a first engaging upright portion 11 with a first diameter while the second side forming a second engaging upright portion 12 with a second diameter that constitutes a two-way assembling device of the auxiliary lock. Furthermore, the monolithic assembling plate 1 includes a connecting hole 13, at least two screw holes 14, at least two first through holes 15 and at least two second through holes 16. In manufacture, the first engaging upright portion 11 and the second engaging upright portion 12 are coaxial and punched by a press machine. The first engaging upright portion 11 and the second engaging upright portion 12 are relief structures located at opposite sides of the monolithic assembling plate 1. Preferably, the first diameter of the first engaging upright portion 11 and the second diameter of the second engaging upright portion 12 are 38 mm and 54 mm respectively. The diameters meet the sizes of the assembling holes 61, 61′ of a normal door plank 6, as best shown in FIGS. 2 and 4.

Still referring to FIG. 1, the first engaging upright portion 11 forms the connecting hole 13 and the screw holes 14 while the second engaging upright portion 12 forms the second through holes 16. The first through holes 15 are disposed on the outermost periphery of the monolithic assembling plate 1. To secure the monolithic assembling plate 1 to the assembling holes 61, 61′ of the door plank 6, the first through holes 15 and the second through holes 16 permit passage of first fixing members 51, as best shown in FIGS. 2 and 4.

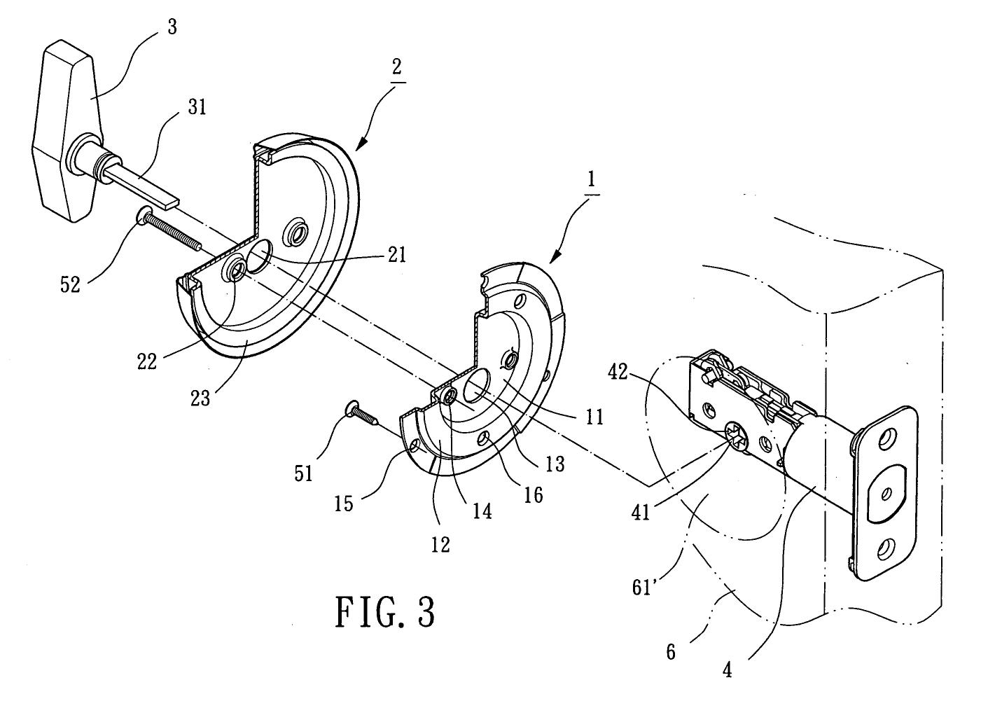

Referring again to FIGS. 1 and 3, construction of the rose escutcheon 2 shall be described in detail. The rose escutcheon 2 includes a connecting hole 21, at least two screw holes 22 and a reinforcing plate 23. The connecting hole 21 and the screw holes 22 of the rose escutcheon 2 are corresponding to the connecting hole 13 and the screw holes 14 of the monolithic assembling plate 1 when assembled. The screw holes 14 and 22 permit passage of second fixing members 52 so as to combine the monolithic assembling plate 1 with the rose escutcheon 2 to constitute a assembled unit. To reinforce the construction of the escutcheon 2, the reinforcing plate 23 forms with a thick metal plate which is fixed or secured to an inner surface of the rose escutcheon 2.

Still referring to FIGS. 1 and 3, construction of the doorknob 3 shall be described in detail. The doorknob 3 connects to an actuating rod 31 which successively extends through the connecting hole 13 of the monolithic assembling plate 1 and the connecting hole 21 of the rose escutcheon 2. Also, the actuating rod 3 extends through the assembling hole 61 of the door plank 6. Finally, a distal end of the actuating rod 31 connects to the latch mechanism 4.

Still referring to FIGS. 1 and 3, construction of the latch mechanism 4 shall be described in detail. Initially, the latch mechanism 4 is installed in the assembling hole 61 of the door plank 6. The latch mechanism 4 includes an actuating wheel 41 and an engaging slot 42 thereof. The distal end of the actuating rod 31 engages with the engaging slot 42 of the latch mechanism 4 and actuates the actuating wheel 41 of the latch mechanism 4.

Referring back to FIG. 2, when the monolithic assembling plate 1 is installed in a diameter of 38 mm of the assembling hole 61 of the door plank 6, the first side of the monolithic assembling plate 1 must face the assembling hole 61. The first engaging upright portion 11 of the monolithic assembling plate 1 is inserted into and engaged with the assembling hole 61 and thus the assembling hole 61 is faced with the monolithic assembling plate 1. Subsequently, the first fixing members 51 extend through either of the first through holes 15 or the second through holes 16, and screw-connects to the periphery of the assembling hole 61 of the door plank 6. Preferably, the doorknob 3 is rotatably connected to the rose escutcheon 2 and the actuating rod 31 of the doorknob 3 extends through the connecting hole 21 of the rose escutcheon 2. The second fixing members 52 extend through the screw holes 14 and 22 of the monolithic assembling plate 1 and the rose escutcheon 2 so that the rose escutcheon 2 secures to the monolithic assembling plate 1. Consequently, the monolithic assembling plate 1 is able to secure to the assembling hole 61 of the door plank 6 by employing the first engaging upright portion 11 and the first fixing members 51.

Referring again to FIG. 4, alternatively, when the monolithic assembling plate 1 is installed in a diameter of 54 mm of another assembling hole 61′ of the door plank 6, the second side of the monolithic assembling plate 1 must face the assembling hole 61′. The second engaging upright portion 12 of the monolithic assembling plate 1 is inserted into and engaged with the assembling hole 61′ and thus the assembling hole 61′ is faced with the monolithic assembling plate 1. Subsequently, the first fixing members 51 extend through the first through holes 15, and screw-connects to the periphery of the assembling hole 61′ of the door plank 6. The second fixing members 52 extend through the screw holes 14 and 22 of the monolithic assembling plate 1 and the rose escutcheon 2 so that the rose escutcheon 2 secures to the monolithic assembling plate 1. Consequently, the monolithic assembling plate 1 is able to secure to the assembling hole 61′ of the door plank 6 by employing the second engaging upright portion 12 and the first fixing members 51.

A single size of the engaging upright portion of the conventional assembling plate is unsuitable for the two diameters of the assembling hole of the door plank at the same time. However, the monolithic assembling plate 1 in accordance with the present invention, as best shown in FIG. 1, has relief structure of the first engaging upright portion 11 and the second engaging upright portion 12 at its either side. The first engaging upright portion 11 and the second engaging upright portion 12 of the monolithic assembling plate 1 are suitable for the two diameters of the assembling hole 61 and 61′ of the door plank 6.

Although the invention has been described in detail with reference to its presently preferred embodiment, it will be understood by one of ordinary skill in the art that various modifications can be made without departing from the spirit and the scope of the invention, as set forth in the appended claims.

1. A two-way assembling device for an auxiliary lock, comprising:
a monolithic assembling plate including a first side and a second side;
a first engaging upright portion consisting of a first relief structure formed on the first side, and having a first diameter; and
a second engaging upright portion consisting of a second relief structure formed on the second side, and having a second diameter corresponding to the first diameter of the first engaging upright portion;
wherein the first engaging upright portion and the second engaging upright portion are coaxially arranged, and the first diameter of the first engaging upright portion is substantially smaller than the second diameter of the second engaging upright portion;
wherein one of the first engaging upright portion and the second engaging upright portion is selected and engaged with an assembling hole of a door plank so that the monolithic assembling plate is secured to a periphery of the assembling hole of the door plank, and the monolithic assembling plate is further adapted to combine with a rose escutcheon and a doorknob.

2. The two-way assembling device for the auxiliary lock as defined in claim 1, further comprising at least one first fixing member which extends through at least one first through hole of the first engaging upright portion so that the monolithic assembling plate is secured to the periphery of the assembling hole of the door plank.

3. The two-way assembling device for the auxiliary lock as defined in claim 1, further comprising at least one first fixing member which extends through at least one second through hole of the second engaging upright portion so that the monolithic assembling plate is secured to the periphery of the assembling hole of the door plank.

4. The two-way assembling device for the auxiliary lock as defined in claim 1, further comprising at least one second fixing member which successively extends through each of screw holes of the first engaging upright portion of the monolithic assembling plate and the rose escutcheon so that the monolithic assembling plate and the rose escutcheon are combined.

5. The two-way assembling device for the auxiliary lock as defined in claim 1, wherein the first engaging upright portion has a first connecting hole and the rose escutcheon has a second connecting hole, an actuating rod of the doorknob successively extending through the first connecting hole and the second connecting hole so that the actuating rod is accommodated in the assembling hole of the door plank.

6. The two-way assembling device for the auxiliary lock as defined in claim 5, further comprising a latch mechanism contained in the assembling hole of the door plank, the latch mechanism including an actuating wheel and an engaging slot thereof, a distal end of the actuating rod engaged with the engaging slot for operating the latch mechanism.
